(19) United States
(12) Patent Application Publication
(10) Pub. No.: US 2026/0299763 A1
(43) Pub. Date: Oct. 1, 2026

(54) CONTEXT-BASED PROCESSING OF AI MODEL CANDIDATE RESPONSES

(71) Applicant: East Coast IP, LLC, Raleigh, NC (US)

(72) Inventor: Russell Speight VanBlon, Raleigh, NC (US)

(21) Appl. No.: 19/097,185

(22) Filed: Apr. 1, 2025

(51) Int. Cl. G06F 3/04842; G06F 9/451; G06F 40/20

(52) U.S. Cl. CPC G06F 3/04842; G06F 9/451; G06F 40/20

(57) ABSTRACT

In one aspect, an apparatus includes storage with instructions executable by a processor system to receive a prompt to an artificial intelligence (AI) model, and to identify first and second potential responses to the prompt. The instructions are also executable to present a graphical user interface (GUI) that includes a first selector to provide a first piece of additional context and that includes a second selector to provide a second piece of additional context. The instructions are then executable to present the first potential response as the actual response based on selection of the first selector, and to present the second potential response as the actual response based on selection of the second selector. In some examples, the GUI may be presented prior to either of the first and second potential responses being presented but after both of the first and second potential responses have been generated.

### FIELD

The disclosure below relates to technically inventive, non-routine solutions that are necessarily rooted in computer technology and that produce concrete technical improvements. In particular, the disclosure below relates to context-based processing of artificial intelligence (AI) model candidate responses.

### BACKGROUND

As recognized herein, generative artificial intelligence (AI) models often provide generic responses to user prompts. Then if the user does not get the information that he or she was looking for, the user must then enter another prompt that is different from the initial prompt in the hope of getting a different response that happens to include the information the user desires. This process can be frustrating and time consuming. And more than that, this process consumes undue amounts of power and processor resources as the user overutilizes the AI model in such an iterative manner. No adequate solutions currently exist to the foregoing computer-related, technological problem.

### SUMMARY

Accordingly, in one aspect an apparatus includes a processor system and storage accessible to the processor system. The storage includes instructions executable by the processor system to receive a prompt to an artificial intelligence (AI) model, and to determine that multiple potential responses are providable as an actual response to the prompt. Based on the determination, the instructions are executable to present a graphical user interface (GUI) on a display. The GUI includes a request for additional context to help identify content to provide as the actual response to the prompt. The GUI includes a first selector to provide a first piece of additional context, with the first selector being selectable to trigger presentation of a first response as the actual response. The GUI also includes a second selector to provide a second piece of additional context, with the second selector being selectable to trigger presentation of a second response as the actual response. The first piece of additional context is different from the second piece of additional context. Responsive to selection of the first selector, the instructions are executable to present the first response as the actual response. Responsive to selection of the second selector, the instructions are executable to present the second response as the actual response.

In some example embodiments, the AI model may include a large language model (LLM), and here the actual response may include a text-based response. Also in some example embodiments, the AI model may include a large multimodal model (LMM) and the actual response may include a non-text-based response. For example, the non-text-based response may include a generative still image, a generative video, and/or generative audio.

What's more, in some implementations the first piece of additional context and the second piece of additional context may both be associated with a same type of information. In one particular instance, the same type of information may include an age of a subject indicated in the prompt.

In some example embodiments, responsive to selection of the first selector, the instructions may be executable to edit the prompt to remove previously-provided text and to include the first piece of additional context. The instructions may then be executable to submit the edited prompt with the first piece of additional context to the AI model for generation of the actual response. Responsive to selection of the second selector, the instructions may be executable to edit the prompt to remove previously-provided text and include the second piece of additional context. The instructions may then be executable to submit the edited prompt with the second piece of additional context to the AI model for generation of the actual response.

In other example embodiments, responsive to selection of the first selector, the instructions may be executable to augment the prompt by adding the first piece of additional context to the prompt without removing text from the prompt. The instructions may then be executable to submit the augmented prompt with the first piece of additional context to the AI model for generation of the actual response. Responsive to selection of the second selector, the instructions may be executable to augment the prompt by adding the second piece of additional context to the prompt without removing text from the prompt. The instructions may then be executable to submit the augmented prompt with the second piece of additional context to the AI model for generation of the actual response.

In still other example embodiments, responsive to selection of the first selector, the instructions may be executable to select the first response as the actual response as that response has been generated by the AI model as a potential response prior to selection of the first selector. Responsive to selection of the second selector, the instructions may be executable to select the second response as the actual response as that response has been generated by the AI model as a potential response prior to selection of the second selector.

In addition, in some example implementations, the apparatus may include a client device and a server in communication with each other to provide the actual response.

Also in some example implementations, the apparatus may include a server that communicates with a client device to present the GUI and the actual response.

In another aspect, an apparatus includes at least one computer readable storage medium (CRSM) that is not a transitory signal. The at least one CRSM includes instructions executable by a processor system to receive a prompt to an artificial intelligence (AI) model. The instructions are also executable to, based on the prompt, identify a first potential response to the prompt and a second potential response to the prompt. Based on the identification of the first and second potential responses, the instructions are then executable to present a graphical user interface (GUI) on a display. The GUI includes a request for additional context to help identify which of the first potential response and the second potential response to provide as an actual response to the prompt. The GUI includes a first selector to provide a first piece of additional context, with the first selector being selectable to trigger presentation of the first potential response as the actual response. The GUI also includes a second selector to provide a second piece of additional context, with the second selector being selectable to trigger presentation of the second potential response as the actual response. The first piece of additional context is different from the second piece of additional context. Responsive to selection of the first selector, the instructions are executable to present the first potential response as the actual response. Responsive to selection of the second selector, the instructions are executable to present the second potential response as the actual response.

In some examples, the apparatus may include the processor system and/or the display.

Also in some examples, the AI model may include a large language model. Additionally or alternatively, the AI model may include a generative image model, a generative video model, and/or a generative audio model. Also in certain examples, the AI model may include an Internet search model.

What's more, in some example embodiments the GUI may be presented prior to either of the first and second potential responses being presented, but after both of the first and second potential responses have been generated by the AI model.

In still another aspect, a method includes receiving a prompt to an artificial intelligence (AI) model. Based on the prompt, the method includes identifying a first potential response to the prompt and identifying a second potential response to the prompt. Based on the identification of the first and second potential responses, the method includes presenting a graphical user interface (GUI) on a display. The GUI includes a request for additional context to help identify which of the first potential response and the second potential response to provide as an actual response to the prompt. Responsive to receipt of the additional context, the method includes identifying one of the first potential response and the second potential response to provide as the actual response. Based on the identification, the method includes providing one of the first potential response and the second potential response as the actual response.

In some non-limiting examples, the GUI may be presented prior to either of the first and second potential responses being presented, but after both of the first and second potential responses have been generated by the AI model.

### BRIEF DESCRIPTION OF THE DRAWINGS

The details of the present application, both as to its structure and operation, can be best understood in reference to the accompanying drawings, in which like reference numerals refer to like parts, and in which:

FIG. 1 is a block diagram of an example computing system consistent with present principles;

FIG. 2 shows an example graphical user interface (GUI) through which an initial prompt to an AI model may be submitted consistent with present principles;

FIG. 3 shows an example GUI that may be presented consistent with present principles for an end-user to ergonomically provide additional context for the AI model to then provide an appropriate output in response;

FIG. 4 shows an example GUI that presents a generative output determined based on ergonomic selection of additional context provided to the AI model consistent with present principles;

FIG. 5 shows another example GUI consistent with present principles that may be presented for an end-user to ergonomically provide additional context for the AI model to then provide an appropriate output in response;

FIG. 6 shows example logic in flow chart format that may be executed by an apparatus consistent with present principles; and

FIG. 7 shows an example GUI that may be presented at an end-user's display for the user to configure one or more settings of a device or app to operate consistent with present principles.

### DETAILED DESCRIPTION

This disclosure relates generally to aspects of consumer electronics (CE) devices and other types of client devices and servers. Thus, devices herein may include server and client components which may be connected over a network such that data may be exchanged between the client and server components. The client components may include one or more computing devices including mobile smart phones and other mobile devices, wearable devices, game consoles, extended reality (XR) headsets such as virtual reality (VR) headsets and augmented reality (AR) headsets, display devices such as televisions (e.g., smart TVs, Internet-enabled TVs), personal computers such as laptops, desktop, and tablet computers, and still other types of devices. These client devices may operate with a variety of operating environments. For example, a client device consistent with present principles may employ, as examples, Linux and Unix operating systems, operating systems from Microsoft, or operating systems from Apple or Google. These operating environments may be used to execute one or more browsing programs, such as a browser made by Microsoft, Apple, Google, or Mozilla. The operating environments may also be used to execute other Internet-networked dedicated mobile applications that can access websites hosted by the Internet servers over a network such as the Internet, a local intranet, or a virtual private network.

Servers and/or gateways may be used that may include one or more processors executing instructions that configure the servers to receive and transmit data over a network such as the Internet. Or a client and server can be connected over a local intranet or a virtual private network. A server or controller may be instantiated by a personal computer, mobile device, rack or blade server, etc.

As indicated above, information may be exchanged over a network between client devices and servers. To this end and for security, servers and/or clients can include firewalls, load balancers, temporary storages, and proxies, and other network infrastructure for reliability and security.

As used herein, instructions may refer to computer-implemented steps for processing information in the system. Instructions can be implemented in software, firmware or hardware, or combinations thereof and include any type of programmed steps undertaken by components of the system.

A processor may be any single- or multi-chip processor that can execute logic by means of various lines such as address lines, data lines, and control lines and registers and shift registers. Moreover, any logical blocks, modules, and circuits described below can be implemented or performed with a processor/processor system such as a central processing unit (CPU), a digital signal processor (DSP), a field programmable gate array (FPGA) or other programmable logic device, an application specific integrated circuit (ASIC), discrete gate or transistor logic, discrete hardware components, or any combination thereof designed to perform the functions described herein. A processor can be implemented by a controller or state machine or a combination of computing devices.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

The functions and methods described below, when implemented in software, can be written in an appropriate language such as but not limited to hypertext markup language (HTML)-5, Java®/Javascript, C # or C++, and can be stored on or transmitted from a computer-readable storage medium such as a hard disk drive (HDD) or solid state drive (SSD), random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

In an example, a processor system can access information over its input lines from data storage, such as a computer readable storage medium as referenced above, and/or the processor system can access information wirelessly from an Internet server by activating a wireless transceiver to send and receive data. Data typically is converted from analog signals to digital by circuitry between the antenna and the registers of the processor system when being received and from digital to analog when being transmitted. The processor system then processes the data through its shift registers to output calculated data on output lines, for presentation of the calculated data on the device, etc.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

Note that present principles may also employ machine learning models, including deep learning models. Machine learning models use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as one or more convolutional neural networks (CNNs) and/or one or more recurrent neural networks (RNNs) (such as a type of RNN known as a long short-term memory (LSTM) network). Support vector machines (SVM) and Bayesian networks also may be considered to be examples of machine learning models.

As understood herein, performing machine learning involves accessing and then training a model on training data to enable the model to process further data to make predictions. A neural network may include an input layer, an output layer, and multiple hidden layers in between that are configured and weighted to make inferences about an appropriate output.

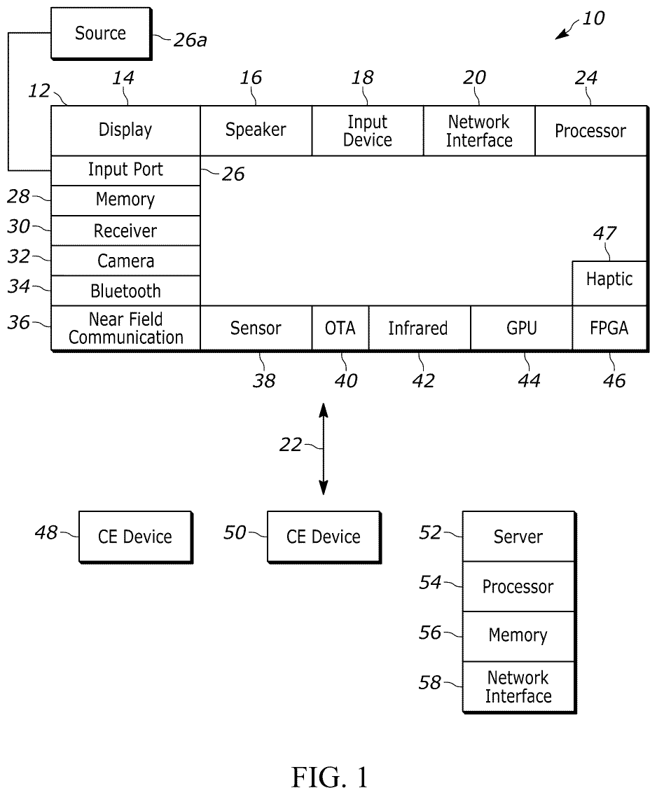

Referring now to FIG. 1, an example system 10 is shown, which may include one or more of the example devices mentioned above and described further below in accordance with present principles. The first of the example devices included in the system 10 is a consumer electronics (CE) device 12. The CE device 12 may be a computerized Internet enabled (“smart”) phone, a tablet computer, a laptop/notebook computer, a desktop computer, a head-mounted device (HMD) and/or headset such as smart glasses or AR or VR headset, another wearable computerized device, etc. Regardless, it is to be understood that the CE device 12 is configured to undertake present principles (e.g., communicate with other CE devices and servers to undertake present principles, execute the logic described herein, and perform other functions and/or operations described herein).

Accordingly, to undertake such principles the CE device 12 can be established by some, or all, of the components shown. For example, the CE device 12 can include one or more touch-enabled displays 14 that may be implemented by a high definition or ultra-high definition “4K” or higher flat screens. The touch-enabled display(s) 14 may include, for example, a capacitive or resistive touch sensing layer with a grid of electrodes for touch sensing consistent with present principles (e.g., to provide input to the GUIs discussed below).

The CE device 12 may also include an analog audio output port 15 to drive one or more external speakers or headphones, and may include one or more internal speakers 16 for outputting audio in accordance with present principles, and at least one additional input device 18 such as an audio receiver/microphone, e.g., for conversing telephonically or for entering audible commands to the CE device 12 to control the CE device 12. The example CE device 12 may also include one or more wired or wireless network interfaces 20 for communication over at least one network 22 such as the Internet, a WAN, a LAN, etc. under control of one or more processors of a processor system 24, such as a CPU or other processor mentioned above. Thus, the interface 20 may be, without limitation, a Wi-Fi transceiver and/or wireless telephony transceiver for communicating over a wireless cellular network (e.g., operated by Verizon, T-Mobile, or AT&T), both of which are examples of a wireless computer network interface.

It is to be understood that the processor system 24 may include one or more processors acting independently or in concert with each other to execute an algorithm (e.g., the algorithms referenced herein), whether those processors are in one device or more than one device. Thus, in some specific examples, the processor system may include a single processor, while in other examples the processor system may include more than one processor. The processor system 24 controls the CE device 12 to undertake present principles, including the other elements of the CE device 12 described herein such as controlling the display 14 to present images thereon and receiving input therefrom. Furthermore, also note the network interface 20 may be a wired or wireless modem or router or other suitable network interface.

In addition to the foregoing, the CE device 12 may also include one or more input and/or output ports 26 such as a high-definition multimedia interface (HDMI) port or a universal serial bus (USB) port to physically connect to another CE device, and/or a headphone port to connect headphones to the CE device 12 for presentation of audio from the CE device 12 to a user through the headphones. For example, the input port 26 may be connected wired or wirelessly to a cable or satellite source 26a of audio video content. Thus, the source 26a may be a separate or integrated set top box, or a satellite receiver. Or the source 26a may be a game console or disk player containing content.

The CE device 12 may further include one or more non-transitory computer memories/computer-readable storage media 28 such as disk-based or solid-state storage that are not transitory signals, in some cases embodied in the chassis/housing of the CE device 12 (e.g., as standalone devices) or as removable memory media or the below-described server(s). Also, in some embodiments, the CE device 12 can include a position or location receiver such as but not limited to a cell phone transceiver, global positioning system (GPS) transceiver, and/or altimeter 30. This transceiver may therefore be configured to receive geographic position information from a satellite or cellphone base station (and/or determine an altitude at which the CE device 12 is disposed) and then provide the information to the processor system 24. However, it is to be understood that another suitable position receiver other than a GPS receiver, cell phone transceiver, and/or altimeter may be used consistent with present principles to determine the location of the CE device 12. In some examples, the GPS transceiver 30 may be located on a streetlight or other infrastructure for which location is to be reported for purposes described in greater detail below.

Continuing the description of the CE device 12, in some embodiments the CE device 12 may include one or more cameras 32 that may be thermal imaging cameras, digital cameras such as webcams, infrared (IR) sensors, and/or other types of cameras or other optical sensors integrated into the CE device 12 and controllable by the processor system 24 to gather pictures/images and/or video consistent with present principles. Also included on the CE device 12 may be a Bluetooth® transceiver 34 and/or other Near Field Communication (NFC) element 36 for communication with other devices using respective Bluetooth and/or NFC wireless technologies/communication standards. An example NFC element can be a radio frequency identification (RFID) element.

Further still, the CE device 12 may include one or more auxiliary sensors 38 that provide input to the processor system 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

Other sensor examples include a motion sensor such as an accelerometer, gyroscope, magnetometer, a speed and/or cadence sensor, an event-based sensor, a gesture sensor (e.g., for sensing gesture command), etc. In one specific example, the sensor 38 thus may be implemented as an inertial measurement unit (IMU) with motion sensors including individual accelerometers, gyroscopes, and magnetometers, and/or other components of that include a combination of accelerometers, gyroscopes, and magnetometers, to determine the location and orientation of the CE device 12 in three dimensions. A gyroscope consistent with present principles may sense and/or measure the orientation of the CE device 12 and provide related input to the processor system 24, an accelerometer consistent with present principles may sense acceleration and/or movement of the CE device 12 and provide related input to the processor system 24, and a magnetometer consistent with present principles may sense and/or measure directional movement of the CE device 12 and provide related input to the processor 122.

The CE device 12 may also include an over-the-air TV broadcast port 40 for receiving OTA TV broadcasts and providing the input to the processor system 24. In addition to the foregoing, it is noted that the CE device 12 may also include an IR transceiver 42 such as an IR data association (IRDA) device. A battery (not shown) may be provided for powering the CE device 12, as may a kinetic energy harvester that may turn kinetic energy into power to charge the battery and/or power the CE device 12. A graphics processing unit (GPU) 44 and field programmable gated array 46 also may be included.

One or more haptics/vibration generators 47 may also be provided for generating tactile signals/vibrations that can be sensed by a person holding or in contact with the device. The haptics generators 47 may thus vibrate all or part of the CE device 12 using an electric motor connected to an off-center and/or off-balanced weight via the motor's rotatable shaft so that the shaft may rotate under control of the motor (which in turn may be controlled by a processor such as the processor system 24) to create vibration of various frequencies and/or amplitudes as well as force simulations in various directions.

In addition to the CE device 12, the system 10 may include one or more other CE devices/types, which may include some or all of the components mentioned above in relation to the CE device 12. In one example, a second CE device 48 may be established by an Internet of things (IoT) device, a smartphone, a laptop computer, etc. A third CE device 50 is also shown in FIG. 1 and may include similar components as the other CE devices. Thus, in one example, the CE device 50 may be configured as a head-mounted display (HMD) that may include a heads-up transparent or non-transparent display for respectively presenting extended reality (XR) content such as AR content, VR, content, and/or mixed reality (MR) content. The XR content itself might include, as an example, one or more of the GUIs described below, presented stereoscopically. The HMD may be configured as a glasses-type display, or as goggle-type and/or VR-type display vended by various computer hardware manufacturers such as Apple, Oculus, Meta, etc. Or the CE device 50 may be established by a smart streetlight consistent with present principles and, as such, the smart streetlight may include a network communication interface (e.g., Wi-Fi transceiver and/or cellular data transceiver) for communicating with other devices to implement present principles.

In the example shown, only three CE devices are shown, it being understood that fewer or more devices may be used. A device herein may implement some or all of the components shown for the CE device 12. Any of the components shown in the following figures may incorporate some or all of the components shown in the case of the CE device 12.

Now in reference to the afore-mentioned at least one server 52, it includes at least one server processor 54 and at least one tangible computer readable storage medium 56 such as disk-based or solid-state storage. The server 52 also includes at least one network interface 58 that, under control of the server processor 54, allows for communication with other illustrated devices over the network 22 (e.g., the Internet), and indeed may facilitate communication between the server 52 and any other servers/client devices as described herein. Note that the network interface 58 may be, e.g., a wired or wireless modem or router, Wi-Fi or Ethernet transceiver, or other appropriate interface such as, e.g., a wireless telephony transceiver.

Accordingly, in some embodiments the server 52 may be an Internet server or an entire server “farm” of multiple services. If desired, the server 52 may include/perform “cloud” functions such that the devices of the system 10 may access a “cloud” environment via the server 52 in certain example embodiments. Additionally or alternatively, the server 52 may be implemented by one or more computers in the same room as the other devices shown, or nearby.

The components shown in the following figures may include some or all components shown herein. Any user interfaces (UI) described herein may be consolidated and/or expanded, and UI elements may be mixed and matched between UIs. UIs may be presented at a client device like the CE device 12 under control of the client device itself and/or under control of the server 52 as remotely controlling the CE device 12 to present the UIs thereon. Also note that selectors and options on the UIs discussed below may be selected via cursor input, touch input to a touch-enabled display on which the GUI is presented, using voice input, and/or using other input methods.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Attention-based architectures or transformer-based architectures may be used. Generative pre-trained transformers (GPT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

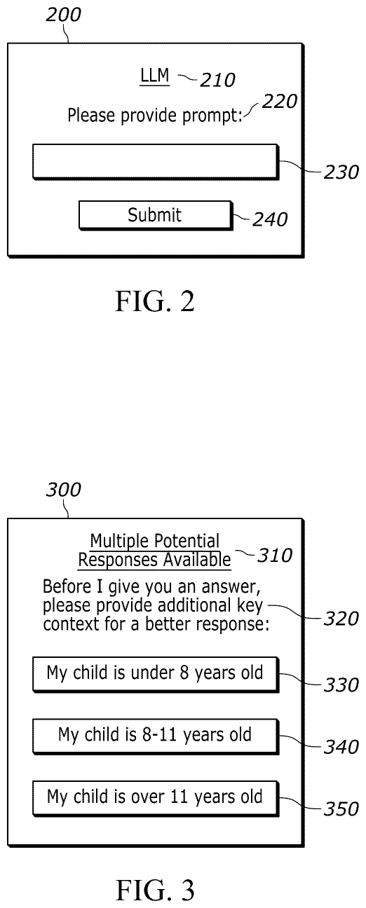

With the foregoing in mind, suppose an end-user wishes to use an AI model such as a generative text model to receive a text-based response from the AI model. The AI model might be a large language model (LLM) establishing some or all of a conversational chatbot that interfaces with the user. The LLM may therefore be established by a generative pre-trained transformer (GPT) similar to Chat GPT, Gemini, Claude, Llama, Grok, or DeepSeek. The user might access the AI model over the Internet using a browser or dedicated software application (“app”) being executed by the local operating system on the user's client device. With reference to FIG. 2, a GUI 200 may then be presented as an initial prompt screen for the user to subsequently enter an initial text-based prompt to the AI model.

As such, FIG. 2 shows that the GUI 200 may include an AI model name 210 (generically “LLM” per this example) as well as a request 220 that a user prompt be provided. The user may then use a hard or soft keyboard to enter text into text entry field 230, and then select the submit selector 240 using touch input or cursor input to provide the text entered into the field 230 as input to the AI model.

Now suppose the AI model has determined that multiple potential responses can be provided as an actual response to the user's prompt. The AI model might do so based on its execution to provide an output in response to the prompt, with the output including multiple candidate responses of different weights that have each been generated by the AI model as alternative responses. The different candidate responses might therefore establish different generative outputs for different contexts, with none of those contexts being provided by the user as part of the initial prompt itself.

Or, in another example, the AI model might not yet have generated the different generative responses themselves but has still determined, during its initial execution stages, that multiple different responses might be generated and provided depending on additional context that has not yet been supplied by the user.

In either case, the GUI 300 of FIG. 3 may be presented in response. As shown in FIG. 3, the GUI 300 may include a text-based request 310 for additional context to help the AI model identify content to provide as the actual response. The request 310 may also include an explanation 320 that, before the AI model provides an answer to the user's prompt, additional context from the user may be key to providing a targeted, tailored response.

Thus, the GUI 300 may include plural selectors 330-350 that are each selectable to provide a different additional context. Advantageously, this allows the user to ergonomically provide additional context without reengineering the initial prompt to then have the AI model iterate again on the reengineered prompt after it has already been executed at least one time beforehand. This ergonomic aspect also improves the functioning of the system itself as this technique saves power and limits undue consumption of processor resources by obviating the aforementioned iterative approach where the AI model is executed multiples times to get to the generative response that the user desires.

As shown in FIG. 3, the different pieces of additional context that are being requested in the present instance are both associated with a same type of information. Assume per this example that the user is asking for advice on how to discuss a particular topic with the user's child, and as such the AI model may request context in the form of the age of the child. So here, the same type of information is the age of the subject (the child) indicated in the initial prompt itself. Accordingly, the GUI may include a first selector 330 to provide a first piece of additional context, a second selector 340 to provide a second piece of additional context, and a third selector 350 to provide a third piece of additional context. Each selector 330-350 is selectable to trigger presentation of a respective first, second, or third response as the actual response.

Note that in the present example, the selector 330 indicates that the associated additional context is that the user's child is under eight years old. The selector 340 indicates that the associated context is the user's child being between eight and eleven years old, and the selector 350 indicates that the associated context is the user's child being over the age of eleven years old.

Also note that each of the associated contexts may be indicated in metadata from the AI model as output during the initial processing stages of the user's initial prompt, but before one or more complete responses are actually generated and output by the AI model. Additionally or alternatively, in instances where the generative AI model generates multiple complete candidate responses as part of its initial processing of the user's initial prompt before the GUI is even presented, the contexts may be identified by executing natural language processing (e.g., topic identification) on the alternative complete responses to identify the corresponding context for each one. In either case, the different identified contexts for the candidate responses may be indicated via different text on face of each of the respective selectors 330-350.

It may therefore be appreciated that rather than the AI model simply selecting and presenting a highest-weighted response from multiple candidates that were generated based on the user's initial prompt (without additional context), which might result in the user then engaging in further prompt engineering and further power-consuming and processor-intensive executions of the AI model, the AI model may use some or all of the initial prompt along with the additional context provided by the user via the single-click selection of one of the selectors 330-350. The system may use that combined input to either select an already-existing candidate response from the AI model's first iteration, or provide the edited/augmented prompt (with additional context) to the AI model for the AI model to then initiate/complete a response generation on first iteration.

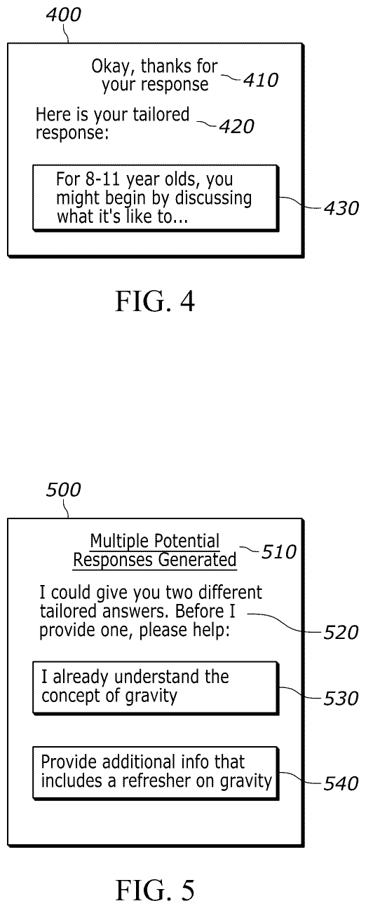

Continuing the example from above, FIG. 4 shows a GUI 400 that may be presented to provide an actual response that is dependent on the additional context provided by the user in terms of the age of the user's child. Accordingly, the GUI 400 includes text 410 indicating that the additional context has been received and processed, along with an indication 420 that a tailored AI model output ensues. The GUI 400 therefore includes the AI model output itself, which includes text 430 indicating “For 8-11 year olds, you might begin by discussing what it's like to...” with the text 430 continuing on with whatever additional generative text was provided by the AI model.

Now in reference to FIG. 5, another example GUI 500 is shown that may be presented on the display of an end-user's client device consistent with present principles. Per this example, suppose the user has provided a prompt asking a generative text AI model to briefly describe Einstein's theory of general relativity. As such and as indicated by indication 510, the AI model has already generated, as part of its initial iteration, multiple candidate responses that might be provided as an actual response to the user's prompt. The indication 510 may include additional text 520 requesting additional context to help identify which of the already-generated (complete) responses to provide as the actual response, with the text 520 indicating that, “I could give you two different tailored answers. Before I provide one, please help:”.

The GUI 500 may thus include two different selectors 530, 540 that are each selectable to provide different additional context that is then used by the system to select one of the available potential responses as the actual response to provide. Accordingly, the first selector 530 may be selected to provide a first piece of additional context—in this case, that the user already understands the concept of gravity more generally—with the first selector being selectable to trigger presentation of an actual response that omits basic information on the concept as gravity. The second selector 530 may be selected to provide a second piece of additional context—in this case, that the user wishes to be provided with additional information that includes a “refresher” on gravity—with the second selector being selectable to trigger presentation of an actual response that includes basic information on the concept of gravity.

Accordingly, responsive to selection of the first selector 530, the system may present the associated first potential response as the actual response. Conversely, responsive to selection of the second selector 540, the system may present the associated second potential response as the actual response.

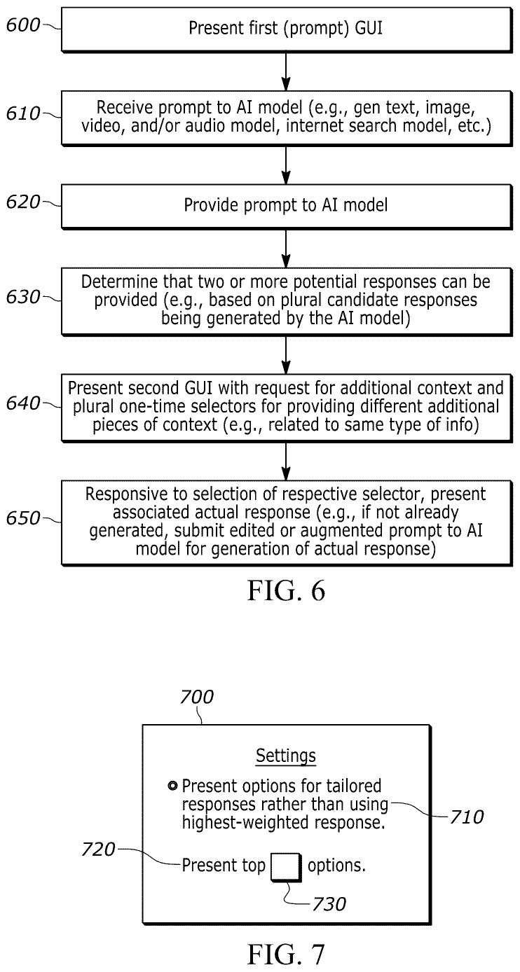

Now in reference to FIG. 6, this figure shows example logic that may be executed by an apparatus such as the CE device 12 (e.g., a client device) and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Thus, in one particular instance, some or all of the logic may be executed by a server that communicates with (e.g., controls) a client device to present the relevant GUIs and AI model outputs at the client device. Or the client device might execute AI model input pre-processing before providing the processed input to the AI model as executing at the server. Further note that while the logic of FIG. 6 is shown in flow chart format, other suitable logic may also be used.

Beginning at block 600, the apparatus may present a first GUI on the client device display, with the end-user being able to enter an initial prompt to the AI model via the first GUI as set forth above. The logic may then proceed to block 610 where the apparatus may receive the user's initial prompt to the AI model via the first GUI, whether the AI model is a generative text model (e.g., an LLM), a generative still image model, a generative video model, and/or a generative audio model (e.g., with the latter three being embodied in a large multimodal model (LMM) that receives text-based prompts to then generate generative media).

Additionally or alternatively, the AI model might be an AI-based Internet search model that is configured to return Internet search results (including, for example, hyperlinks, uniform resource locators (URLs), and/or website descriptors) as matches to an Internet search. The AI-based Internet search model might therefore be similar to Google's search model, DuckDuckGo's search model, Yahoo's search model, Microsoft's search model, etc.

From block 610 the logic may then continue to block 620. Here the apparatus may provide, as input to the AI model, the user's initial prompt. Then at block 630 the apparatus may parse the input using natural language processing (e.g., natural language understanding and/or semantic analysis) and/or using the AI model itself (e.g., using the LLM's semantic analysis) to determine that two or more potential responses might be provided. Additionally or alternatively, if the AI model has already been executed to provide two or more candidate responses based on the initial prompt, the apparatus may determine that at least two candidate responses might be provided based on the output itself and then the candidate responses from the output may be parsed as set forth above to determine the different contexts associated with each one (e.g., using NLP).

From block 630 the logic may then proceed to block 640. Here the apparatus may present a second GUI like one of the GUIs 300 and 500. As such, the second GUI may include a request for additional context to help identify which of a first potential response and a second potential response to provide to the user as an actual response to the user's prompt. The second GUI may therefore include plural single-selection selectors as described above to, without the user providing additional user input like additional text, provide different pieces of context associated with each selector (such as different pieces of context related to the same type of information).

The logic may then proceed to block 650. Here, responsive to receipt of the additional context provided via selection of one of the selectors, the apparatus may identify one of the potential responses to provide as the actual response (e.g., where the potential responses have already been generated based on the initial prompt). Or in instances where complete generative responses have not yet been output by the AI model, the additional context may be provided to the AI model along with the initial prompt for generation of a complete actual response that accounts for the additional context.

Either way, at block 650 the apparatus may ultimately provide one of the potential responses associated with the selected selector as the actual response. Thus, responsive to selection of a first selector from the GUI, the apparatus may present a first potential response as the actual response. And responsive to selection of a second selector from the GUI, the apparatus may instead present a second potential response as the actual response.

It may therefore be appreciated based on the foregoing logic that in one example embodiment, the apparatus may, responsive to selection of the first selector, edit the prompt to remove previously-provided text and include the first piece of additional context, and then submit the edited prompt with the first piece of additional context to the AI model for generation of the actual response. In addition, responsive to selection of the second selector, the apparatus may edit the prompt to remove previously-provided text and include the second piece of additional context, and then submit the edited prompt with the second piece of additional context to the AI model for generation of the actual response. This feature might be used to remove context from the initial prompt that is no longer relevant and insert/replace that context with other context that is now relevant based on the user's selection of the respective selector.

Or for instances where all of the initial prompt is still context-appropriate but the user's selection via the selected selector provides even more context for the processing and output of an appropriate response, the apparatus may do the following responsive to selection of the first selector: the apparatus may augment the prompt by adding the first piece of additional context to the prompt without removing text from the prompt, and then submit the augmented prompt with the first piece of additional context to the AI model for generation of the actual response. In addition, the apparatus may, responsive to selection of the second selector, augment the prompt by adding the second piece of additional context to the prompt without removing text from the prompt, and then submit the augmented prompt with the second piece of additional context to the AI model for generation of the actual response.

In still other instances, as indicated above the AI model may have already been provided with the user's initial prompt as input for the AI model to then generate multiple candidate responses as output. Each candidate response might be weighted differently from the others from high to low in terms of relevance, but each might still have a slightly different context. Therefore, notwithstanding the relevance (or other criteria) rankings, a threshold number of the highest-ranked existing candidate responses may be made available for selection via different selectors for the user to provide additional context as described above. In one instance, with first and second potential responses having already been generated based on the initial prompt prior to selection of either of the first or second selectors for providing additional context, the apparatus may, responsive to selection of the first selector, select the first existing response as the actual response. Or responsive to selection of the second selector, the apparatus may select the second existing response as the actual response. But note here that, either way, the GUI with selectors for providing the additional context may be presented prior to either of the first and second potential responses being presented but after both of the first and second potential responses have already been generated by the AI model.

Now more generally in terms of potential and actual responses, again note that the responses may be established by generative media such as generative still images or video from AI models like diffusion models, such as Stable Diffusion or DALL-E 2, that have been trained for outputting generative images. Or the responses may be generative audio recordings generated by one or more generative adversarial networks (GANs) trained for audio recording generation. In some instances, large multimodal models (LMM) may be used in which multiple different types of text and media may be provided as input to the LMM for the LMM to then generate a text-based (generative text) actual response and/or non-text-based (generative image, video, audio) actual response.

Also note consistent with present principles that in some instances, an audio user interface may be used for the user to audibly speak the initial prompt and then provide audible commands selecting one or more options for providing additional context (as audibly or visually presented by the apparatus). The apparatus might then audibly output a response correlated to the additional context. One or more digital assistants like Amazon's Alexa or Apple's Siri might therefore be used to audibly interface with the user.

Continuing the detailed description in reference to FIG. 7, this figure shows an example GUI 700 that may be presented on a display for an end-user to configure one or more settings of an apparatus or software app to operate consistent with present principles. Each option discussed below may be selected by selecting that option through cursor input, touch input, or another type of input.

As shown in FIG. 7, the GUI 700 may include a first option 710 that is selectable a single time to set or enable the device/app to undertake present principles in multiple future instances (e.g., executing the logic of FIG. 6 and presenting the other GUIs of FIGS. 2-5, etc. in multiple future instances). The GUI 700 may also include a setting 720 at which the end-user may set a threshold number of highest-weighted identified potential responses (as generated based on an initial prompt alone) for which to present corresponding selectors for providing additional context consistent with the disclosure above. The GUI 700 may therefore include a number entry box 730 at which the user's desired threshold number may be entered. As an example, if the number three were entered into box 730, the top three highest-weighted candidate responses that were generated based on the initial prompt alone may have corresponding selectors presented as part of a GUI like one of the GUIs 300 and 500.

It is to be further understood that, in some instances, an LLM, LMM, or other generative model might initially provide a generic or highest-weighted response on the user's display as generated based on the user's initial prompt alone, with the apparatus storing that potential response along with other lower-weighted potential responses in memory (e.g., RAM) for the user to then provide additional context. The generic or highest-weighted response might therefore be provided with an adjacent icon or other selector (e.g., “more info” button) which might then be selected to cause a pop-up menu to be presented, with the menu listing the selectors for providing different additional contexts as described above. Based on the received additional context, the generic or highest-weighted initial output might then be replaced with another previously-generated potential response that becomes the highest-weighted response on re-ranking in view of the additional context provided by the user.

In one particular aspect, apparatuses and methods consistent with present principles may operate substantially as shown and described above, but may also be claimed as including some but not all aspects in any intermediate claim approach.

Before concluding, it is to be understood that although a software application for undertaking present principles may be vended with a device, present principles apply in instances where such an application is downloaded from a server to a device over a network such as the Internet. Furthermore, present principles apply in instances where such an application is included on a computer readable storage medium that is vended and/or provided by itself, where the computer readable storage medium is not a transitory signal and/or a signal per se.

It may now be appreciated that present principles provide, among other technical improvements, improved computer-based user interfaces that increase the functionality and ease of use of the devices disclosed herein. The disclosed concepts are rooted in computer technology for computers to carry out their functions.

It is to be understood that whilst present principles have been described with reference to some example embodiments, these are not intended to be limiting, and that various alternative arrangements may be used to implement the subject matter claimed herein.

What is claimed is:

1. An apparatus, comprising:
a processor system; and
storage accessible to the processor system and comprising instructions executable by the processor system to:
receive a prompt to an artificial intelligence (AI) model;
determine that multiple potential responses are providable as an actual response to the prompt;
based on the determination, present a graphical user interface (GUI) on a display, the GUI comprising a request for additional context to help identify content to provide as the actual response to the prompt, the GUI comprising a first selector to provide a first piece of additional context, the first selector being selectable to trigger presentation of a first response as the actual response, the GUI comprising a second selector to provide a second piece of additional context, the second selector being selectable to trigger presentation of a second response as the actual response, the first piece of additional context being different from the second piece of additional context; and
responsive to selection of the first selector, present the first response as the actual response; and
responsive to selection of the second selector, present the second response as the actual response.

2. The apparatus of claim 1, wherein the AI model comprises a large language model (LLM), and wherein the actual response comprises a text-based response.

3. The apparatus of claim 1, wherein the AI model comprises a large multimodal model (LMM), and wherein the actual response comprises a non-text-based response.

4. The apparatus of claim 3, wherein the non-text-based response comprises one or more of: a generative still image, a generative video, generative audio.

5. The apparatus of claim 1, wherein the first piece of additional context and the second piece of additional context are both associated with a same type of information.

6. The apparatus of claim 5, wherein the same type of information comprises an age of a subject indicated in the prompt.

7. The apparatus of claim 1, wherein the instructions are executable to:
responsive to selection of the first selector: edit the prompt to remove previously-provided text and to include the first piece of additional context, and submit the edited prompt with the first piece of additional context to the AI model for generation of the actual response; and
responsive to selection of the second selector: edit the prompt to remove previously-provided text and to include the second piece of additional context, and submit the edited prompt with the second piece of additional context to the AI model for generation of the actual response.

8. The apparatus of claim 1, wherein the instructions are executable to:
responsive to selection of the first selector: augment the prompt by adding the first piece of additional context to the prompt without removing text from the prompt, and submit the augmented prompt with the first piece of additional context to the AI model for generation of the actual response; and
responsive to selection of the second selector: augment the prompt by adding the second piece of additional context to the prompt without removing text from the prompt, and submit the augmented prompt with the second piece of additional context to the AI model for generation of the actual response.

9. The apparatus of claim 1, wherein the instructions are executable to:
responsive to selection of the first selector, select the first response as the actual response, the first response being generated by the AI model as a potential response prior to selection of the first selector; and
responsive to selection of the second selector, select the second response as the actual response, the second response being generated by the AI model as a potential response prior to selection of the second selector.

10. The apparatus of claim 1, wherein the apparatus comprises a client device and a server in communication with each other to provide the actual response.

11. The apparatus of claim 1, wherein the apparatus comprises a server that communicates with a client device to present the GUI and the actual response.

12. An apparatus, comprising:
at least one computer readable storage medium (CRSM) that is not a transitory signal, the at least one CRSM comprising instructions executable by a processor system to:
receive a prompt to an artificial intelligence (AI) model;
based on the prompt, identify a first potential response to the prompt and a second potential response to the prompt;
based on the identification of the first and second potential responses, present a graphical user interface (GUI) on a display, the GUI comprising a request for additional context to help identify which of the first potential response and the second potential response to provide as an actual response to the prompt, the GUI comprising a first selector to provide a first piece of additional context, the first selector being selectable to trigger presentation of the first potential response as the actual response, the GUI comprising a second selector to provide a second piece of additional context, the second selector being selectable to trigger presentation of the second potential response as the actual response, the first piece of additional context being different from the second piece of additional context; and
responsive to selection of the first selector, present the first potential response as the actual response; and
responsive to selection of the second selector, present the second potential response as the actual response.

13. The apparatus of claim 12, comprising the processor system.

14. The apparatus of claim 13, comprising the display.

15. The apparatus of claim 12, wherein the AI model comprises a large language model.

16. The apparatus of claim 12, wherein the AI model comprises one or more of: a generative image model, a generative video model, a generative audio model.

17. The apparatus of claim 12, wherein the AI model comprises an Internet search model.

18. The apparatus of claim 12, wherein the GUI is presented prior to either of the first and second potential responses being presented but after both of the first and second potential responses have been generated by the AI model.

19. A method, comprising:
receiving a prompt to an artificial intelligence (AI) model;
based on the prompt, identifying a first potential response to the prompt and a second potential response to the prompt;
based on the identification of the first and second potential responses, presenting a graphical user interface (GUI) on a display, the GUI comprising a request for additional context to help identify which of the first potential response and the second potential response to provide as an actual response to the prompt; and
responsive to receipt of the additional context, identifying one of the first potential response and the second potential response to provide as the actual response; and
based on the identification, providing one of the first potential response and the second potential response as the actual response.

20. The method of claim 19, wherein the GUI is presented prior to either of the first and second potential responses being presented but after both of the first and second potential responses have been generated by the AI model.
